(19) United States
(12) Patent Application Publication
(10) Pub. No.: US 2008/0243350 A1
(43) Pub. Date: Oct. 2, 2008

(54) SYSTEM AND METHOD FOR RECEIVING AND USING DATA ASSOCIATED WITH DRIVING CONDITIONS AND RELATED PARAMETERS

(76) Inventor: Johnnie C. HARKNESS, Hanahan, SC (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/059,958

(22) Filed: Mar. 31, 2008

Related U.S. Application Data
(60) Provisional application No. 60/909,328, filed on Mar. 30, 2007.

(51) Int. Cl. B60T 8/172; G05D 13/02; B60T 8/32; G01P 3/00; B60Q 1/00; G08G 1/09

(52) U.S. Cl. 701/93; 340/441; 340/901

(57) ABSTRACT

A system for controlling a speed of a vehicle includes circuitry coupled to the vehicle for receiving speed threshold data identifying a government-imposed maximum speed limit. The circuitry uses the speed threshold signal to determine a maximum speed value and electronically controls engine performance of the vehicle to maintain the vehicle's speed at or below the maximum speed value.

### CROSS-REFERENCE TO RELATED APPLICATIONS

This application claims priority to U.S. Provisional Application Ser. No. 60/909,328, entitled SYSTEM AND METHOD FOR ADVISING A VEHICLE DRIVER OF A SPEED LIMIT, filed on Mar. 30, 2007, which is incorporated herein by reference in its entirety.

### TECHNICAL FIELD

The present invention relates generally to a system and method for receiving data associated with driving conditions and parameters and, more specifically, to using the conditions and parameters to control a vehicle's speed.

### BACKGROUND OF THE INVENTION

In most areas, there is a specific maximum (and in some instances, also a minimum) speed at which a vehicle can lawfully be driven on a roadway. The maximum speed threshold is often referred to as a speed limit. Speed thresholds are typically posted on road signs with the intent that drivers will see them as they pass by. While maintaining a speed above the minimum speed threshold is rarely a problem for drivers, maintaining a speed below the maximum speed threshold generally requires that the driver watch vigilantly for road signs. Drivers may often find themselves dividing their attention between such road signs and the vehicle speedometer, comparing the speed indicated by the speedometer with the posted speed threshold and taking corrective action, if necessary, to slow down (or in some instances, speed up) so as to avoid driving (unlawfully or unsafely) beyond the speed threshold(s).

In other situations, road construction and/or hazards can temporarily adjust the recommended or mandated speed threshold(s) for a particular roadway. For example, when approaching an area of road construction on a roadway, the speed limit often rapidly changes. In such situations, drivers have to constantly divert their attention away from the road to identify speed threshold signs and compare these signs with their current speed, despite the fact that road construction locations are typically more dangerous for a driver. Road hazards can also cause problems for drivers because drivers are often unaware of their presence in advance. Therefore, road hazards often cause drivers to take unexpected evasive maneuvers that can lead to vehicle accidents/collisions. In addition, weather (such as rain, snow, ice, etc.) can significantly alter recommended/mandated speed threshold(s) due to its effect on driving conditions. Often, drivers do not have adequate advance warning regarding weather conditions, which can lead to unsafe driving conditions. Even if a driver is aware of approaching weather conditions, the driver is often required to divert some of his attention to monitoring the road conditions instead of focusing on other aspects of safe driving.

Regardless of the particular situation, it has been found that the more tasks that a driver is required to perform while driving, the greater the likelihood that the driver will perform one of them incorrectly and thus increase the likelihood of driving unsafely. It would be desirable to improve the ease with which a driver can monitor vehicle speed and take corrective action if necessary. It would also be desirable to improve driver awareness of approaching road hazards and/or conditions that could potentially create driving problems. The present invention addresses these problems and deficiencies and others in the manner described below.

### SUMMARY

The present invention relates to a system and method by which speed threshold information, such as a speed limit, is transmitted via radio signals to a vehicle, such as an automobile or boat. Transmitters can be located near the roadways or other areas where a speed limit has been established. Electronics in the vehicle can use the speed threshold information to alert the driver of the speed limit or hazards. The vehicle electronics can also compare the speed limit with the current vehicle speed and issue an alert if the vehicle is exceeding the speed limit. Driver alerts can be provided by electronic displays, audible warning tones, synthesized speech, etc.

In other embodiments of the invention, a speed threshold RFID can be included in a centralized system located at a centralized location away from the roadway. The vehicle is equipped with a transponder and may be equipped with a Global Positioning System receiver for determining the vehicle's location. The vehicle transmits its location to the centralized system and, in response, the centralized system determines the speed threshold applicable to the vehicle's location and transmits that information to the vehicle.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 depicts an automobile passing a roadside speed threshold transmitter in accordance with a first exemplary embodiment of the invention.

FIG. 2 depicts an automobile having a speed threshold receiver and speed threshold display in accordance with the exemplary embodiment of the invention.

FIG. 3 depicts the speed threshold display mounted in the vehicle dashboard in accordance with the exemplary embodiment of the invention.

FIG. 4 is a schematic view of a vehicle informational system in accordance with a second exemplary embodiment of the invention.

FIG. 5 is a schematic view of a vehicle informational system in accordance with a third exemplary embodiment of the invention.

FIG. 6 is a schematic view of a vehicle informational system in accordance with a fourth exemplary embodiment of the invention.

### DETAILED DESCRIPTION

In the following descriptions of one or more exemplary embodiments of the invention, like reference numerals indicate like components to enhance the understanding of the invention through the description of the drawings. Also, although specific features, configurations, arrangements and steps are discussed below, it should be understood that such specificity is for illustrative purposes only. A person skilled in the relevant art will recognize that other features, configurations, arrangements and steps are useful without departing from the spirit and scope of the invention. Unless specifically noted otherwise, the order in which method steps are described is for illustrative purposes only, and such steps can be arranged in any other suitable order or combined with each other or divided apart in any suitable manner.

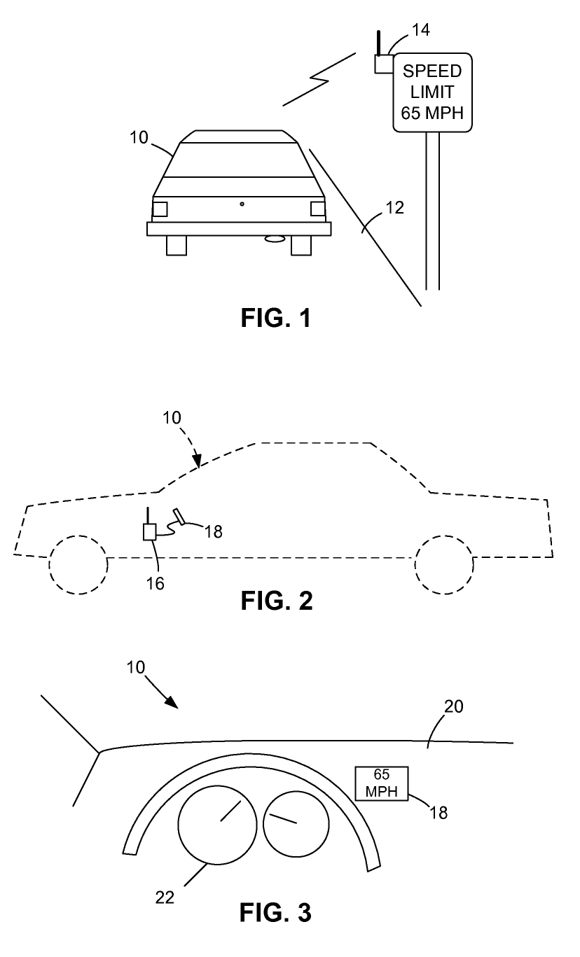

As illustrated in FIGS. 1-6, example embodiments of the present invention generally comprise a vehicle informational system and apparatus for alerting a driver of a vehicle (car, truck, boat, etc.) to road and other driving conditions. In example embodiments as shown in FIGS. 1-3, an automobile 10 driving on a roadway 12 passes by a location at which a Radio Frequency Identification (RFID) tag 14 is disposed. For example, an RFID tag 14 can be co-located with a road sign indicating the speed limit or with any other common roadway feature such as a lamp, mile marker, traffic signal, etc. In example embodiments, an electronic device 16 is coupled to the automobile 10 and includes a radio-frequency transmitter as well as a radio receiver/reader commonly known as a transponder. As the automobile 10 passes the RFID tag 14, the RFID tag 14 wirelessly communicates information to the electronic device 16. The RFID tag can communicate a wide range of information and data to the electronic device 16, such as speed limit information, road conditions, public alerts, weather information, etc. Those skilled in the art will understand that alternatively, the electronic device 16 can be an after market item adapted for use with a current vehicle and/or can be a handheld device.

In depicted embodiments, the electronic device 16 is in communication with an electronic display 18 having one or more visual or audible indicators. The electronic display 18 can be mounted on the vehicle's dashboard 20 or in another suitable location within the automobile 10. The electronic device 16 causes the information received from the RFID tag 14 to be displayed on the electronic display 18. While FIG. 3 shows speed limit information being displayed on the electronic display 18, the display can show other types of information, such as road conditions, alerts, weather information, etc. Although in the illustrated embodiment, the RFID tag 14 transmits the speed limit information in response to detecting the transponder 16, in other embodiments it can transmit the speed threshold information in response to any other suitable condition or transmit the information continuously. In alternative embodiments, the electronic display 18 can include an audio component for audibly conveying the information received from the RFID tag 14 to the driver of the automobile. In still other embodiments, the electronic display 18 can comprise a global positioning system (GPS).

The electronic device 16 can retrieve the speed limit information (or other types of information) from an internal electronic memory source where such information has been pre-stored or, alternatively, from a remote source via a data network. The RFID tag 14 can also retrieve information from an internal memory source, or can be in remote communication with a data network. For example, the RFID tag 14 can be in communication with a local police department, traffic control, state highway patrol etc., such that the information being transmitted by the RFID tag 14 can be remotely updated as necessary.

In addition, the electronic device 16 can determine the vehicle's speed for comparison against the speed threshold information transmitted by the RFID tag 14. In example embodiments, the electronic device 16 is coupled to the vehicle's speedometer 22. Alternatively, the electronic device 16 is coupled to the automobile's engine control unit (not shown) for obtaining the vehicle speed. In still other embodiments, other conventional means for obtaining vehicle speed can be used to transmit the same to the electronic device 16. In example embodiments, the electronic device 16 compares the vehicle speed with the speed limit information to determine if a speed correction should be implemented by the driver of the automobile. In one such example embodiment, if the vehicle speed exceeds a speed threshold, electronic device 16 causes a visual or audible warning to be issued (e.g., on display 18).

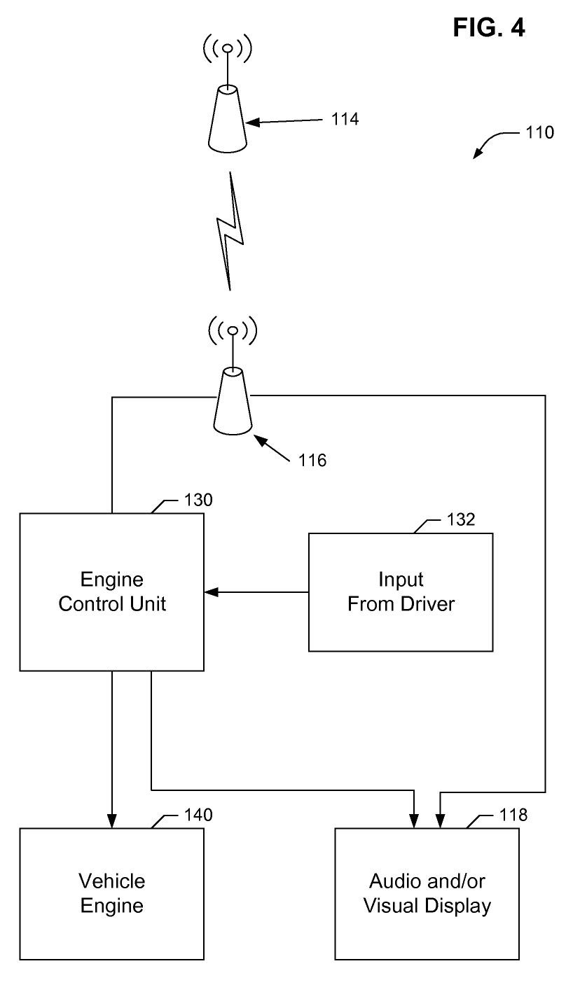

In another example embodiment according to the present invention, as shown in FIG. 4, a system 110 for controlling a vehicle's speed includes a first transponder and/or transceiver 114 in wireless communication with a second transponder and/or transceiver 116. Generally, the transponder 114 is stationary and, as with previous embodiments, can be co-located with road signs, school signs, traffic lights, lamp posts, telephone poles, etc., can be embedded within a roadway, and/or can be placed in other locations in proximity to the roadway. Transponder 116 is generally mobile and can be configured to be coupled to an automobile. Alternatively, transponder 116 can be a handheld device, and/or can be adapted for use within a cell phone, GPS unit, music player, or other mobile electronic device.

In example embodiments, transponder 114 broadcasts information that may be pertinent to drivers operating automobiles. For example, transponder 114 can transmit the speed threshold(s) for the portion of the roadway adjacent to the transponder, weather alerts (such as tornado warnings, freeze/ice warnings, snow warnings, etc.), amber alerts, traffic conditions, road construction alerts, road hazard warnings, school zones, and/or approaching road closures. Such information can be received by the second transponder 116. The transponder 116 can relay the information to an audio and/or visual indicator of the electronic display 118 located within the automobile and/or to an engine control unit 130. Messages or other information transmitted by the first transponder 114 can be displayed (or audibly conveyed) by the display 118 to alert the driver to the particular situation. For example, as an automobile enters a school zone, transponder 114 can broadcast relevant information to the second transponder 116 (such as a reduced speed limit, or school hours), which can then be conveyed to the driver by an indicator on the display 118. Thus, the driver is notified that the vehicle is traveling at a speed in excess of the school zone limit and can take corrective action to appropriately reduce the vehicle's speed.

As seen in FIG. 4, the engine control unit 130 can be electronically coupled to the automobile's engine 140 and can optionally comprise a governor to control the automobile's throttle or otherwise control the vehicle speed. The governor can be a mechanical governor or an electric governor contained within the engine control unit to regulate engine performance. In operation, if the speed limit conveyed by the first transponder 114 (and received by the second transponder 116) is less than the vehicle's speed, the engine control unit 130 can institute the governor (either a mechanical air/fuel reducer or by electronically controlling the performance of the engine) to reduce the vehicle's speed. Alternatively, the engine control unit 130 can be electronically coupled to the vehicle's anti-lock braking system (if the vehicle has anti-lock brakes) and can apply brake pressure to reduce the vehicle's speed accordingly. In still other embodiments, the engine control unit 130 can be in communication with an auxiliary anti-lock brake system (not shown), such as a disc brake oriented along the vehicle's driveshaft or any other deceleration device to reduce vehicle speed. Conversely, if the speed limit conveyed by the first transponder 114 (and received by the second transponder 116) is greater than the vehicle's speed, the engine control unit 130 can release the governor's control over the speed such that vehicle can travel a speed up to the speed limit. Optionally, the system allows the driver to temporarily deactivate system or to exceed the maximum threshold speed for a predetermined amount of time (such as one minute). For example, in certain situations, it would be desirable if the driver can deactivate the system to avoid a collision (e.g., speeding past a truck slowly entering a highway).

The engine control unit 130 can also monitor driver input 132 and compare the driver input with the information received by transponder 116. In such embodiments, the engine control unit 130 can conform to driver input 132 unless the input would cause the automobile to exceed the speed threshold(s) transmitted by the transponder 114. Alternatively, the engine control unit 130 can receive speed threshold information from the transponders 114, 116 and can relay the information along with the current vehicle speed parameters to the indicator 118, such that the driver can easily compare current vehicle speed with the speed threshold(s). The indicator 118 can also issue warnings (visual or audio) to the driver, such as, “the vehicle is currently traveling 5 mph over the speed limit” or “a school zone is approaching—reduce vehicle speed by 20 mph” or “bridge out ahead.” Obviously, one of skill in the art realizes that there are numerous types of warnings and other information that can be conveyed to the driver using the present invention.

In additional example embodiments, every transponder 116 can have a unique identification number or other unique identifier that is broadcast when the vehicle is in operation. Alternatively, the transponder 116 can broadcast all the time, or only when desired by the driver of the automobile. Regardless, the identification number can serve to identify the automobile to others, such as local police, highway patrol, etc. In other example embodiments, police or highway patrol workers can send signals to the transponder 116 as needed to slow, stop, or otherwise control the engine of the automobile. Such embodiments are particularly useful when police officers are trying to stop a high-speed car chase, slow down a speeding vehicle, or stop an automobile theft from occurring by allowing the officers to access the engine control unit 130 of the automobile.

The transponder 116 can also be utilized to broadcast signals to the roadside transponder 114. In example embodiments, the transponder 114 can collect data from passing automobiles, such as vehicle speed information, traffic data, driver license information, automobile registrations, etc. This data can be then be broadcast by the transponder 114 to local authorities as desired.

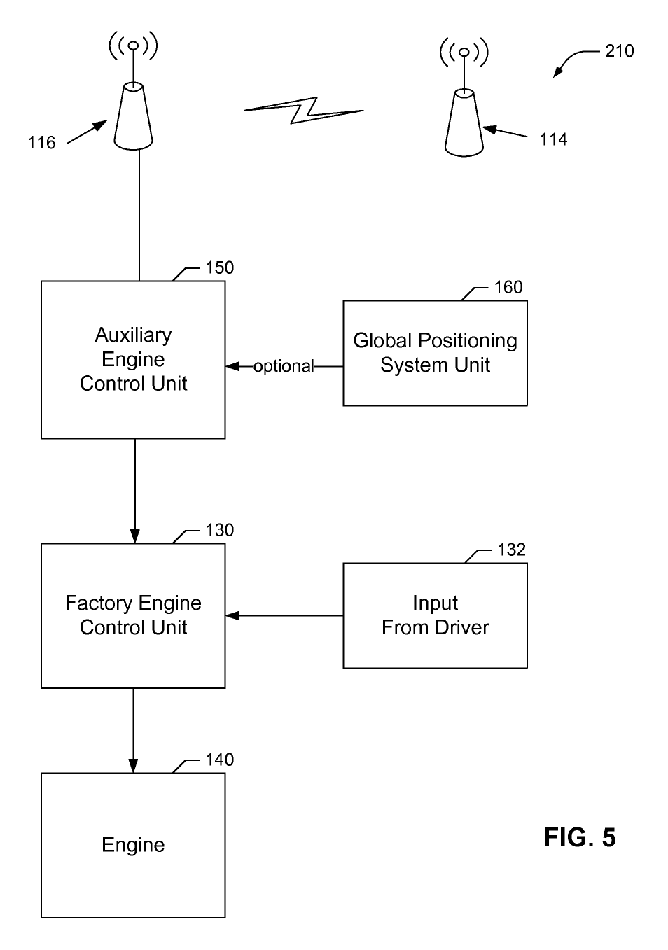

In another example embodiment of the present invention, as shown in FIG. 5, the present invention can also comprise an auxiliary engine control unit 150 in communication with a mobile transponder 116. The auxiliary engine control unit can be operable to communicate with the factory engine control unit 130 of an automobile without modifying the automobile's control unit 130. The auxiliary control unit 150 can be implemented as a kit in conjunction with one or more mobile transponders 116. The kit can be used as an aftermarket add-on to retrofit an automobile to permit the automobile to transmit and receive information related to driving conditions. The kit can include one or more electrical and/or mechanical couplings for connecting the auxiliary control unit 150 to the automobile's engine control unit 130. The kit can further include one or more brackets and fasteners for physically attaching the auxiliary control unit 150 to the vehicle.

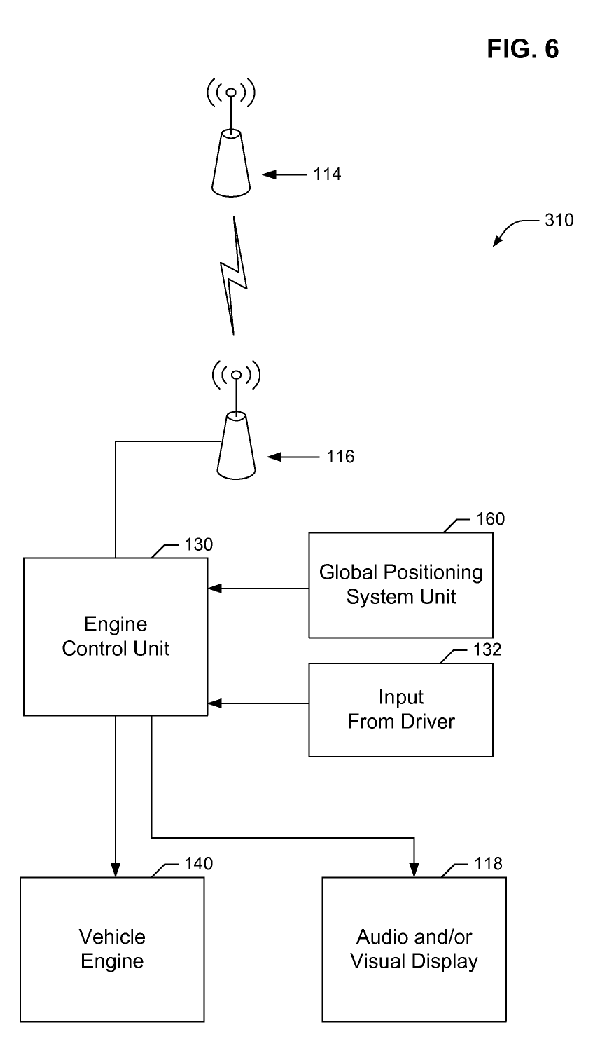

FIGS. 5-6 demonstrate systems 210 and 310 for controlling a vehicle's speed according to other example embodiments of the present invention. The systems 210 and 310 are substantially similar to one another and are similar to the system 110 with the addition of a GPS unit 160. In the system 210 of FIG. 5, the GPS unit 160 provides data to the auxiliary engine control unit 150, while in the system 310 of FIG. 6, the GPS unit 160 directly provides data to the engine control unit 130. In such embodiments, the GPS unit 160 directly provides speed threshold information pre-programmed on a storage device within the unit or it can obtain speed threshold information from a corresponding satellite. The GPS unit 160 determines the vehicle's location and compares the vehicle's location with known speed threshold information (either stored in memory or obtained via satellite communication). The relevant speed threshold information can be transmitted to the engine control unit 130 (or auxiliary engine control unit 150) to control the engine performance of the automobile or can be merely displayed on the indicator 118 to allow speed correction to take place at the driver's election. In other embodiments, transponders 114 and 116 can be used to override the GPS information when the GPS data is not current. For example, when traveling on an interstate highway, the speed thresholds are typically between 40 mph and 70 mph. The GPS unit 160 can be pre-programmed to output these speed thresholds to the driver based on the location of the automobile. However, if temporary speed thresholds are established due to road conditions, such as construction, ice, hazards, etc., the transponders 114 and 116 can override the threshold data from the GPS unit 160 to give the driver the most accurate information. In this manner, it is conceivable that roadside transponders 114 can be set up only in areas where special information is needed.

In some example embodiments, the system of the present invention can be activated and deactivated by the driver as desired. For example, the driver can simply push a button to activate or deactivate the system. In another embodiment, the system may include one or more security features to prevent the unauthorized or inadvertent deactivation of the system. For example, the system can require one or more of a valid password, biometric data, or other inputs to deactivate itself. Absent a valid response to the security measures, the system will remain activated. This embodiment may be especially useful for parents of teenage drivers by eliminating the possibility that the teenage driver would deactivate the system. In other embodiments, the system is always activated such the driver cannot override the limitations imposed by the system.

Those skilled in the art will understand that systems of the present invention can include user-imposed maximum speed limits. For example, a parent of a teenage driver can program the auxiliary control unit to prevent the car from travelling at speeds higher than 40 mph, for example. Optionally, the system can include a data storage device to store some or all data related to the vehicle's speed, driver's response to warnings, etc. Such data can be then be viewed at a later time either on the vehicle's electronic display or downloaded to a computer, PDA, cellular phone, or the like.

Those skilled in the art will further understand that the systems of the present invention can further cooperate with a vehicle's cruise control module. In such embodiments, the vehicle transponder of the present invention receives speed limit data (from any source) and then in conjunction with the cruise control module, maintains the vehicle's speed at a speed that equals the maximum speed limit. Alternatively, the cruising speed can be selected as some value below the maximum speed limit (e.g., 3 mph below the maximum speed limit).

It will be apparent to those skilled in the art that various modifications and variations can be made to this invention without departing from the spirit or scope of the invention. Thus, it is intended that the present invention covers the modifications and variations of this invention provided that they come within the scope of any claims and their equivalents.

What is claimed is:

1. A system for controlling a speed of a vehicle, comprising:
circuitry coupled to the vehicle for receiving speed threshold data identifying a government-imposed maximum speed limit, wherein the circuitry uses the speed threshold signal to determine a maximum speed value and electronically controls engine performance of the vehicle to maintain the vehicle's speed at or below the maximum speed value.

2. The system of claim 1, wherein the speed threshold data is received from an RFID tag coupled to a roadside speed limit sign.

3. The system of claim 1, wherein the speed threshold signal data is retrieved from a storage device of a global positioning unit.

4. The system of claim 3, wherein the storage device resides on a centralized server in communication with the global positioning unit.

5. The system of claim 1, further comprising a display for conveying information related to vehicle's speed.

6. The system of claim 5, wherein the display provides visual data.

7. The system of claim 5, wherein the display provides audible data.

8. The system of claim 5, wherein the display further conveys one of hazard, weather, safety, and emergency data.

9. The system of claim 1, wherein the circuitry can be selectively activated and deactivated by a user.

10. A kit for retrofitting a vehicle with a speed control unit, comprising:
the speed control unit;
an electromechanical coupling for coupling the speed control unit to an engine control unit of the vehicle; and
one or more fasteners for mechanically fastening the speed control unit to the vehicle.

11. A method for limiting a speed of a vehicle to a government-imposed speed limit, comprising:
receiving speed limit data for the road currently being traveled;
comparing the vehicle's current speed with the speed limit data; and
if the vehicle's current speed exceeds the speed limit data, then causing the vehicle's speed to be decreased to a value that is the same as or lower than the government-imposed speed limit.

12. The method of claim 11, wherein the step of causing the vehicle's speed to be decreased further includes electronically controlling the performance of the vehicle's engine to reduce the vehicle's speed.

13. The method of claim 11, wherein the step of causing the vehicle's speed to be decreased further includes activating the vehicle's braking system.

14. The method of claim 13, wherein the step of activating the vehicle's braking system includes activating an auxiliary brake system.

15. The method of claim 14, wherein the auxiliary brake system comprises a disc brake oriented along a driveshaft of the vehicle.

16. A system for conveying and using data associated with driving parameters, comprising:
a plurality of transmitters, wherein each of the plurality of transmitters is positioned proximate a road and wherein each of the plurality of transmitters transmits data including a maximum speed limit for an associated portion of the road;
a transponder located within a travelling vehicle, wherein the transponder receives data from one of the plurality of transmitters which is in proximity to the transponder; and
a display in communication with the transponder to convey the data to a driver of the vehicle.

17. The system of claim 16, further comprising:
a vehicle control unit that receives speed limit data from the transponder and causes the vehicle to adjust its travelling speed accordingly.
